(19) United States
(12) Patent Application Publication
(10) Pub. No.: US 2011/0173521 A1
(43) Pub. Date: Jul. 14, 2011

(54) PRESENTATION CONTENT MANAGEMENT AND CREATION SYSTEMS AND METHODS

(75) Inventors: William James Horton, Queensland (AU); Giles Kingsley Newton, Queensland (AU); Richard Frank Skelly, Queensland (AU); David Chodyra, Queensland (AU)

(73) Assignee: DIRECT TV PTY LTD, Stafford (AU)

(21) Appl. No.: 11/996,240

(22) PCT Filed: Jul. 19, 2006
(86) PCT No.: PCT/AU2006/001019

§ 371 Date: Jul. 22, 2008

(30) Foreign Application Priority Data
Jul. 19, 2005 (AU) 2005903805

(51) Int. Cl. G06F 17/00

(52) U.S. Cl. 715/202

(57) ABSTRACT

A presentation content management and creation system (10) comprises a database (30) of sorted media components coupled to be in communication with a controller (50) for scheduling and rendering media components selected from the database into a real time media presentation. At least one output device (14) is coupled to be in communication with the controller for outputting the real time media presentation and the controller renders the selected media components as the real time presentation is being communicated to the at least one output device.

### FIELD OF THE INVENTION

The present invention relates to presentation content management and creation systems and methods.

### BACKGROUND TO THE INVENTION

Presentations such as advertising are a ubiquitous feature of modern life and efforts are continually being made to devise improved methods of effective presentation and in particular advertising. One commonplace form of advertising found in, for example, retail outlets, trade shows and the like comprises a display, such as a CRT or LCD screen, coupled to a computer terminal or playback device, such as VCR or DVD player, which displays images and plays audio to typically promote products and/or services.

A more sophisticated system is disclosed in United States Patent Application Publication No. US 2003/0191688 in the name of Prince et al. The disclosed system, method and storage device comprises a commercial display services application having a user interface that allows users to select and program advertising content from databases of diverse media formats such as audio-video advertising content, static advertising content and audio-clip content. This system therefore allows users to tailor the content of the advertising to particular customers.

However, one drawback of both of the aforementioned advertising systems is that the advertisements are pre-produced, they are presented in a fixed series or sequence and are continuously repeated, for example, throughout the day in a looped arrangement. Research has demonstrated that repeated exposure to the same advertisements can result in potential customers “tuning out” the advertisements. Additionally, employees are exposed to the repeated advertisements for hours, days and even weeks, which provides for an undesirable work environment. Although employees can look away from the display, the audio is usually unavoidable, which can result in the volume being reduced by employees thus deteriorating the effectiveness of the advertising on the potential customers. The negative effect on the employees can also be transferred to the potential customers, which can impact negatively on sales.

Another system for delivering advertising content and other information is disclosed in WO 00/057308 assigned to Frankel and Company. Template multimedia presentations are assembled at a central location for a plurality of remote sites. The template multimedia presentations are transmitted to the remote sites over a wide area network, Internet or the like, and are stored on players at their respective sites. The players automatically access an enterprise database to retrieve data useful for modification of the template multimedia presentation into a site-specific multimedia presentation, preferably at predetermined intervals. The result is a site-specific multimedia presentation incorporating changing enterprise data. Whilst this system provides improved efficiency in the distribution and presentation of advertisements, flexibility is limited because the site-specific multimedia presentations can only be modifications of the template multimedia presentation.

U.S. Pat. No. 6,526,411 in the name of Ward discloses a system and method for creating dynamic play lists that allow for the dynamic addition and subtraction of play list items. The system and method takes into consideration user preferences, user behaviour and the availability of new content. The system maintains a database of linkages between elements associated with content items as well as weighted linkages between elements and respective properties. When a new item is inserted into the database, the new item shares preference weights and a number of preferences associated with items pre-existing in the database. Whilst this system and method enables users to experience new items that correlate with the specified user preferences or other bases for framing an initial input list that otherwise might not have been considered, the system and method only deals with such factors when a player of the system is presenting pre-produced and deployed content. Consequently, the play lists disclosed in this patent are only dynamic in the sense that new, discrete items of pre-produced content can be inserted in the play list.

US 2002/0138641 also discloses the concept of the dynamic play list and has the objective of a system for a media producer to dynamically string media clips together while reducing or eliminating delays between media clips. A system and method are disclosed in which a dummy play list is created that causes a media player to request media clips from a proxy server. The proxy server dynamically determines where to redirect the requests resulting in the dynamic arrangement of the sequence of media clips to be played. Therefore, the benefits of this system and method are also limited because they can only deal with how such choices could be made dynamically when the player is presenting pre-produced and deployed content. Furthermore, this system and method are directed exclusively to streamed media content and a variety of streaming media players.

Similarly, a system for electronically distributing, displaying and controlling advertising and other communicative media disclosed in WO 01/078273 is also limited to only varying a schedule of discrete, pre-produced items of content. WO 01/078273 discloses a need to vary the content and its sequencing after it has been deployed. Media content to be displayed according to a schedule together with dynamic data to be displayed according to another overlying schedule are mixed in a scheduler according to logs of user preferences and monitored, formatted and loaded for display in a scene renderer.

WO 01/050401 discloses a system and method for distributing and controlling the output of media in public spaces and discloses the concept of the dynamic play list, the introduction of local content and the addition of further content relevant to the consumer. It defines the output of related media to multiple devices as synchronization or synchronized delivery. A transient state variable interface module is disclosed that receives data reflecting transient conditions relevant to the public space. A logic controller module then dynamically selects between available media based at least in part on the state of the transient state variables. This document also has the disadvantage of being limited to varying pre-produced content.

Hence, current presentation solutions rely heavily on pre-produced media components, which limits the flexibility and control of such solutions because significant changes to the media components are not possible. In the case of, for example, a video file, all of the control over the components typically exists when the media is being created in a program such as Adobe® Premiere®. Therefore when this media is later played back, the control over each component that made up the video file is gone. Another disadvantage is that pre-produced media components, such as video files, tend to be large and therefore take longer to distribute. The large file size does not allow distribution of the media to be prompt if such distribution needs to be done across a network, such as the Internet.

Hence, there is a need for a system, method and/or apparatus to address or at least ameliorate one or more of the aforementioned problems of the prior art or provide a useful commercial alternative.

In this specification, the terms “comprises”, “comprising”, “including” or similar terms are intended to mean a non-exclusive inclusion, such that a method, system or apparatus that comprises a list of elements does not include those elements solely, but may well include other elements not listed.

### SUMMARY OF THE INVENTION

In one form, although it need not be the only or indeed the broadest form, the invention resides in a presentation content management and creation system comprising:

a database of sorted media components;

a controller coupled to be in communication with the database for scheduling and rendering media components selected from the database into a real time media presentation;

at least one output device coupled to be in communication with the controller for outputting the real time media presentation;

wherein the controller renders the selected media components as the real time presentation is being communicated to the at least one output device.

Suitably, the system further comprises an administrator module coupled to be in communication with the database and the controller.

The database, the controller and the administrator module may be coupled to be in communication in a store control unit.

Preferably, the media components selected from the database include at least one static media component and/or at least one dynamic media component.

The dynamic media component may be selected when a change in the real time presentation is required.

Preferably, at least one attribute of at least one of the dynamic media components is determined by the controller. Examples of attributes include, but are not limited to: colour, opacity, position, size, duration, volume, layer order, text size, text style, blend level transparency or combinations thereof.

The system may further comprise a customer demographic database coupled to be in communication with a user interface and the database of sorted media components. The user interface may also function as the at least one output device.

In response to one or more selections made by a user via the user interface, the real time media presentation is communicated to the at least one output device.

The one or more selections made by the user may include selecting whether or not advertisements are to be included in the real time media presentation.

If advertisements are to be included in the real time media presentation, the advertisements are selected by the controller on the basis of data relating to the user stored in the customer demographic database.

Suitably, the advertisements are selected from an advertisement database coupled to be in communication with the controller.

In one embodiment, the media components scheduled and/or rendered by the controller are determined at least partially in response to signals detected by one or more of the following devices coupled to be in communication with the controller: an image capturing device, a motion sensor, a sensitive/voice activated screen.

In another form, the invention resides in a controller for a presentation content management and creation system, said controller comprising:

a scheduler module for selecting media components from a database of sorted media components and creating a play-list of scheduled media components; and

a renderer module for rendering the scheduled media components into a real time media presentation as the real time presentation is being communicated to at least one output device coupled to be in communication with the controller.

The scheduler module may randomly select media components from the database of sorted media components via a list of media components stored in the controller.

Suitably, the media components are sorted at least by a media category or subcategory required in the presentation.

Preferably, the scheduler and the renderer module separate the scheduled media components into dynamic components and static components and the renderer module combines the static components and the dynamic components in the real-time presentation.

Suitably, the dynamic components, if required, are selected according to one or more identifying parameters specified for the dynamic components.

Preferably, the renderer module reselects at least one of the dynamic components when a change in the real-time presentation is required.

The renderer module may change the presentation of a media component due to an internal input and/or an external input.

In a further form, the invention resides in a method of creating a presentation including:

selecting media components from a database of sorted media components;

creating a play-list of scheduled media components; and

rendering the scheduled media components into a real time media presentation as the real time presentation is being communicated to at least one output device.

The method may further include separating the media components constituting the scheduled media into dynamic components and static components.

The method may further include changing at least one of the dynamic components when a change in the real time media presentation is required.

Changing at least one of the dynamic components may include:

determining a type and at least one parameter of the at least one dynamic component that requires changing; and

selecting a replacement component from at least one component list according to the parameters.

Preferably, the method further includes combining the static components and the dynamic components in the real-time media presentation.

The method may further include recording details of the media components for auditing purposes once displayed in the real time media presentation.

Further features of the present invention will become apparent from the following detailed description.

### BRIEF DESCRIPTION OF THE DRAWINGS

By way of example only, preferred embodiments of the invention will be described more fully hereinafter with reference to the accompanying drawings, wherein:

FIG. 1 is a schematic representation of a presentation content management system according to an embodiment of the present invention;

FIG. 2 is a schematic representation of operations of a controller for the presentation content management system shown in FIG. 1;

FIG. 3 is a flowchart showing the steps performed by a scheduler module of the controller;

FIG. 4 is a flowchart showing the steps performed by a renderer module of the controller;

FIG. 5 is a schematic representation of a system for a first application of the present invention;

FIG. 6 is a schematic representation of the first application of the present invention; and

FIG. 7 is a schematic representation of a second application of the present invention.

### DETAILED DESCRIPTION OF THE INVENTION

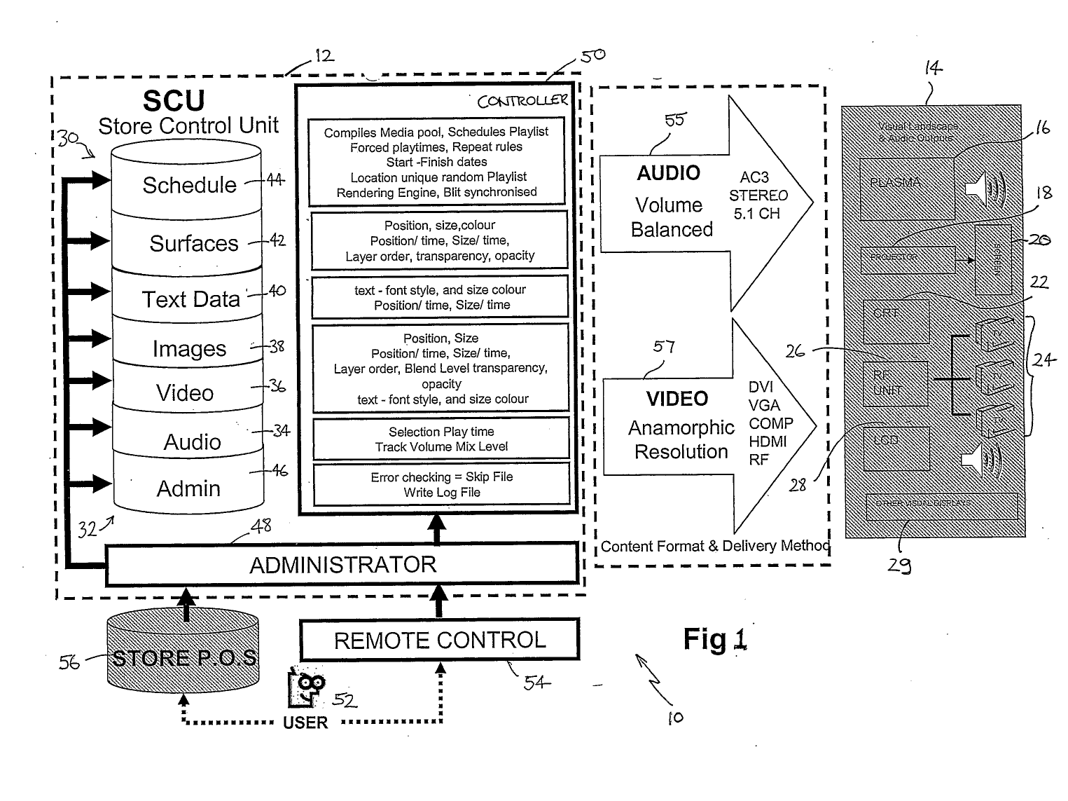

Referring to FIG. 1, there is provided a presentation content management system 10 according to an embodiment of the present invention comprising a store control unit (SCU) 12 coupled to be in communication with one or more visual and audio output devices 14. The output devices 14 can be, for example, a plasma screen 16, a projector 18 and screen 20, a CRT 22, a plurality of CRTs 24 coupled to an RF unit 26 and/or a LCD screen 28, or other forms of visual and audio displays 29.

The SCU 12 comprises a database 30 of media components 32, such as audio 34, video, 36, images 38 and text data 40 as well as surface data 42, schedules 44 and administrative data 46. Database 30 is coupled to be in communication with an administrator module 48, which is coupled to be in communication with a controller 50. A user 52 can interact with the SCU 12 via the administrator module 48 via a user interface device which is linked to the administrator module 48 via the remote control module 54 and/or a point-of-sale (POS) terminal 56. The SCU 12 provides audio content 55 and video content 57 to the output devices 14. The audio content 55 can utilise third generation audio coding (AC3) from Dolby Laboratories delivered via 5.1 channel or stereo. The video content 57 can be presented in anamorphic resolution using DVI, VGA, COMP, HDMI or RF communications.

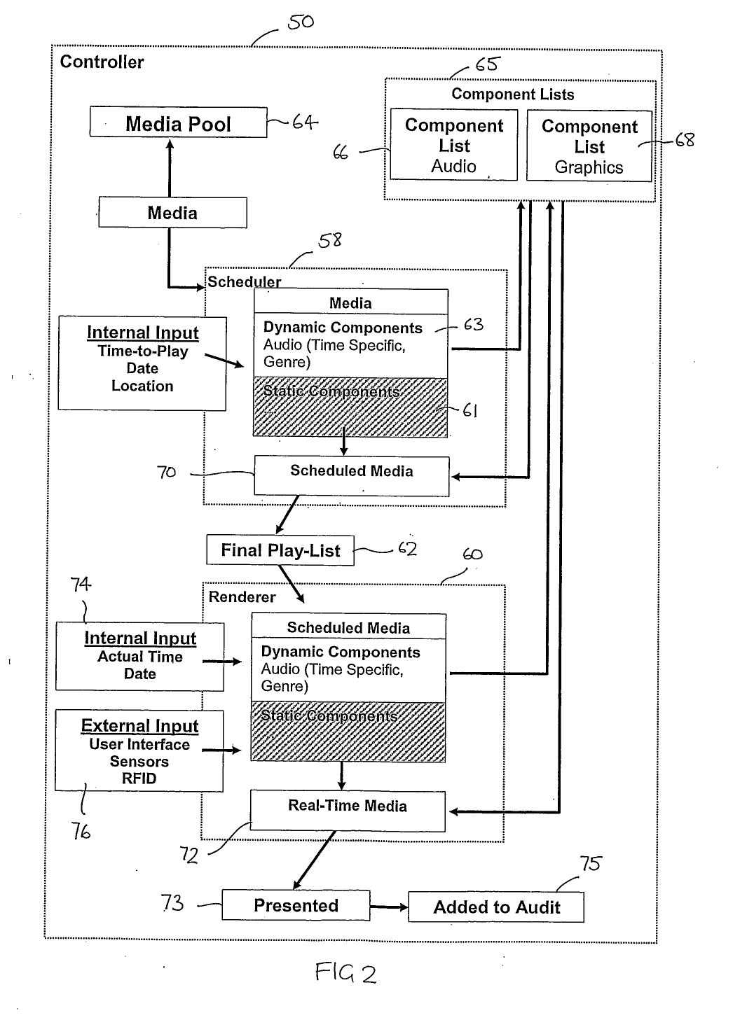

With reference to FIG. 2, the controller 50 comprises a scheduler module 58 coupled to be in communication with a renderer module 60. The scheduler module 58 generates a play list 62 of media to be presented over a predetermined time period and the renderer module 60 presents the media from the play list.

Media is defined herein as a collection of one or more components that can be static (predetermined) 61 or dynamic (selected during run-time) 63. Media can be the actual media to be presented, such as an audio video interleave (.avi) file, or media can be a description of one or more components 32 to be presented. Each media description contains a category, a subcategory and a time duration/length. A component can be anything that is applied or presented by the system 10. Examples of components 32 are audio, graphics, video, text and two- and/or three-dimensional objects. A dynamic component 63 has a list of parameters, each of which contains one or more criteria that allow it to be, or prevent it from being, selected at run-time by the scheduler module 58. Such parameters can be a time/date range, a genre, an audience classification and so on.

The controller 50 maintains a list of media in a media pool 64. Media listed in the media pool can be filtered by category and/or subcategory which is integral to the scheduling process. The controller 50 also maintains one or more lists of components 65, grouped by the component type. For example, there may be an audio component list 66 and a video component list 68 each of which can be filtered by genre, audience classification, appropriate time of day or night to run and so on.

As the scheduler module 58 generates the play-list 62, the dynamic components 63 of each media are selected. The dynamic components 63 are varied according to a set of required parameters that the media describes. Such required parameters may be, for example, the location of the system, the time the media is scheduled to play and so on. The required parameters allow the scheduler module 58 to select an appropriate component from the component lists 65 for the dynamic component 63 in the media. An example of this can be media which contains a dynamic component 63 that is a piece of audio to be played during the media. This piece of audio could vary according to when the media was scheduled to play. The audio desired during the day for example can differ to the audio desired at night. As well as scheduling dynamic components 63, the scheduler module 58 can vary the presentation of media caused by an input. An example of this is varying the volume of audio and video media components during a busier part of the day when the ambient volume is typically higher.

Once media has been scheduled it is known as scheduled media 70. Once the scheduler module 58 has generated a final play-list 62, the renderer module 60 takes over and begins presenting the scheduled media 70. As the scheduled media is played, it is known as real-time media 72. Once presented 73, details of the media presented are recorded for auditing and billing purposes 75. Once scheduled media is taken from the final play-list it can be dynamically adjusted or modified by the renderer module 60 in response to an internal input 74 and/or an external input 76. Internal inputs 74 are within the system 10 such as time and date inputs. For example, if media is played later then expected, the media can be adjusted to suit the new parameters. External inputs are external to the system 10 such as the user interface device, examples of which include a touch screen, an audio/visual sensor or an RFID scanner. Such internal and/or external inputs can also affect how media or the schedule is presented. An example of this may be a user triggering a sensor that increases the volume of the media or causes different media to be loaded and presented. The scheduled media can be dynamically adjusted up to 30 times per second within a time line of the presentation to provide an unprecedented level of flexibility in media presentation.

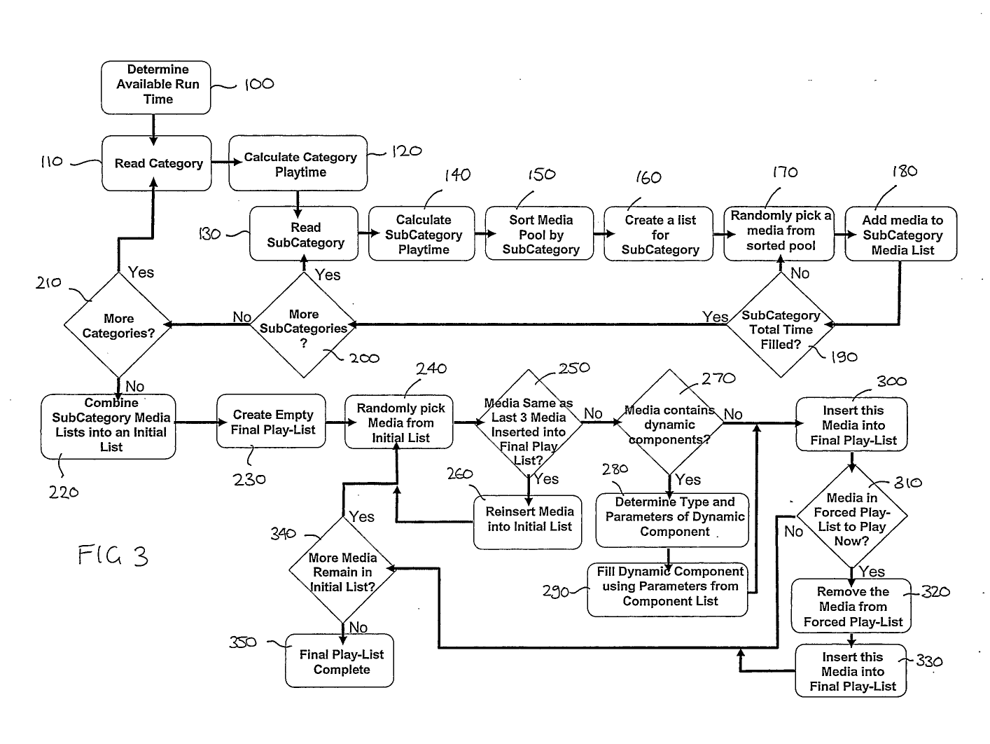

The scheduling process performed by the scheduler module 58 will now be described in more detail with reference to the flowchart in FIG. 3. In step 100, the scheduling process determines the total amount of time available. The scheduler module 58 takes the difference between any predetermined time/date and the current time/date as the total run time.

In step 110, the details of a category are read and the available schedule time is divided into a user-specified amount of categories. Each category is given a weighting (percentage totaling 100%), which determines how much of the total time that category receives in the presentation. A category run time is calculated by using the percentage weight against the total run time, as represented by step 120. The category weight is added to a running total to ensure the total does not exceed 100%.

Within each category, one or more user-specified subcategories are chosen to distribute the time share of each category. Each subcategory is read in step 130 and a run time for each subcategory is calculated in step 140. The rules of each subcategory applied to the category run time can calculate the amount of time allocated to each subcategory.

In step 150, the media pool 64, which is the list of all media in the system 10, is sorted or filtered by category and subcategory to generate a subcategory list for the relevant sub-category, as represented by step 160. A new subcategory list will be generated for each subcategory.

In step 170, media is randomly selected from the subcategory list. The media within the subcategory list is randomly selected to fulfil the time share of each subcategory as evenly as possible to ensure one piece of media is not played a disproportionate amount of time or the majority of the time. The randomly selected media from the subcategory list are added to a subcategory media list, as represented by step 180.

With reference to step 190, if more time is available to be filled for that subcategory, further media are picked from the subcategory list. No more time is available for further media of a particular category when the subcategory media-list has reached its subcategory run-time. According to one embodiment, the subcategory run-time is reached when the total length of all media in the subcategory media-list is greater then 30 seconds less than the subcategory run-time and less than 120 seconds more than the subcategory run-time. Rules are applied to the randomly chosen media to ensure one piece of media is not chosen predominantly over any other.

If no more time is available, with reference to step 200, if further subcategories are required, steps 130-190 are repeated. If no more subcategories are required, the enquiry is made whether further categories are required in step 210. If so, steps 110-200 are repeated. If not, the subcategory media lists are combined into an initial media list, as represented by step 220.

With reference to step 230, an empty final play-list is created to store all the final media clips. The final play-list is a schedule of media that must be played and the times at which it must be played. Therefore, the first media to be inserted into the final play-list will have a time-to-play (TTP) that equals the time the scheduler module 58 began scheduling. The second media will have a TTP of when the scheduler began to schedule plus the length of time of the first media and so on. As each media is inserted into the final play-list, the TTP of the next media to be played is determined by adding the TTP and length of the current media.

With reference to step 240, the final play-list is filled by randomly picking media from the initial list, which contains the appropriate amount of media for each subcategory. Various repeat rules can be applied at this time. One such rule can be that as media is randomly chosen from the initial list for the final play-list, a check is made to ensure this media has not already been scheduled to play in the previous three media scheduled to play, as represented by step 250. If the media has been played in any of the previous three media, with reference to step 260, the media is reinserted into the initial list and in step 240 media is randomly chosen again from the initial list.

With reference to step 270, once media has been selected for insertion into the final play-list at a proposed time to play, the media is checked for dynamic components. A dynamic component is a part of the media that is variable and determined at run time. It is determined by one or more required parameters. These parameters give criteria for selecting a component to insert into the media. Such parameters may include, but are not limited to, the proposed time to play, the location of the system 10, or the output devices 14 thereof, the date a schedule is being generated and a genre. With reference to steps 280, if the media contains one or more dynamic components, the scheduler module 58 will determine the type and the required parameters of each dynamic component and, with reference to step 290, using the component lists 65 shown in FIG. 2, the scheduler module 58 will pick one or more appropriate components to insert.

In addition to selecting components dynamically at run-time, the scheduler module 58 can also control the application/presentation of components based on different parameters. Therefore, the presentation of media can differ due to, for example, being presented at different times of the day. Such parameters can include, but are not limited to, the proposed time to play (TTP), the location of the system 10, or the output devices 14 thereof, and the date a schedule is being generated. This is dynamically performed at run-time and can be applied to all media within the system 10.

Once media has been inserted into the final play list, as represented by step 300 in FIG. 3, a check is made against a forced play-list, as represented by step 310. The forced play-list contains a list of media which is scheduled to run at an exact time. A check is made against the forced play-list after media is inserted into the final play-list to ensure that the media in the forced play-list are played as close to the specified time as possible. If media in the forced play-list is due to be played at the current time, the media is removed from the forced play-list, as represented by step 320, and is inserted in the final play-list as represented by step 330. If media in the forced play-list is not due to be played at the current time, the method of the scheduler module 58 proceeds to step 340.

With reference to step 340, if more media remains in the initial list, more media is randomly picked from the initial list in step 240. If not, once all checks have been made and all required media is inserted into the final play-list, the final play-list is complete, as represented by step 350 and, with reference to FIG. 2, it becomes known as scheduled media 70. This simply means that this media has passed the scheduler module 58 and has been given a time-to-play.

With reference to FIG. 2, the rendering process presents scheduled media 70 from the final play-list 62. Once scheduled media 70 is taken from the final play-list 62, it is known as real-time media 72. To present the media, the renderer module 60 first separates all the individual components and each component is prepared individually for presentation. As scheduled media is presented, the renderer module 60 has the opportunity to alter the presentation of components due to one or more internal inputs 74 and/or one or more external inputs 76, as described above. After each real-time media 72 is presented, the next is taken from the final play-list 62.

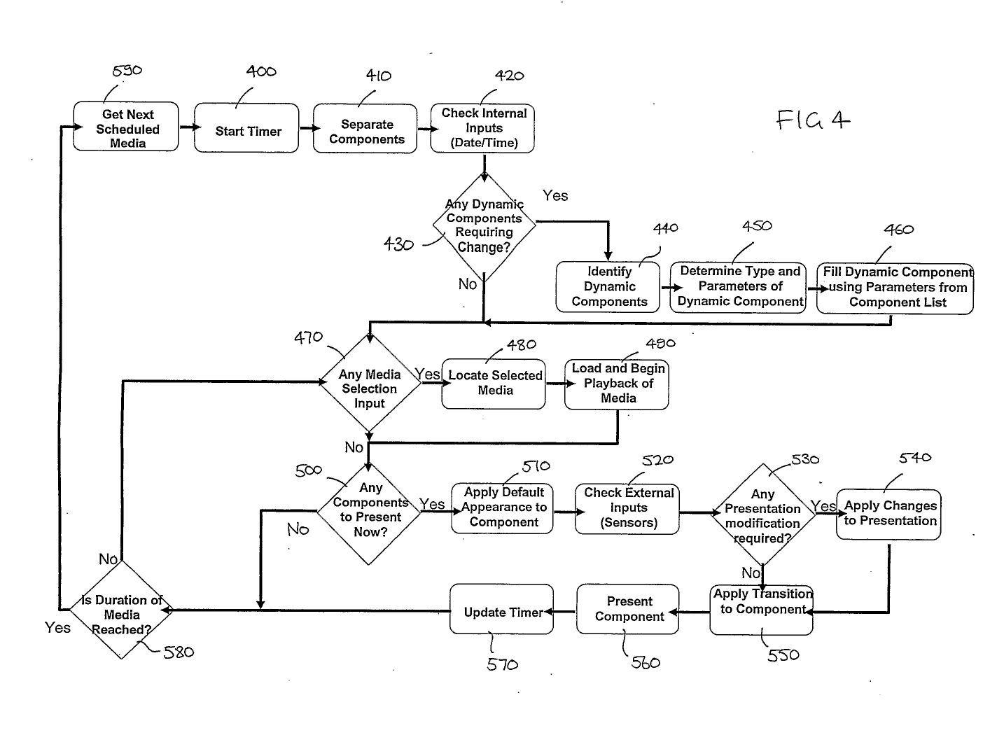

The rendering process will now be described in more detail with reference to the flowchart in FIG. 4. With reference to step 400, the first step in the rendering process is to begin a timer. This timer allows the renderer module 60 to keep track of the effects and components that must be processed. Once a timer is in place, the media can be split up into its individual components, as represented by step 410. Referring to step 430, to determine if there are any changes necessary to any dynamic components in the media, a check is made against all the internal inputs such as date and time, as represented by step 420. If the current time is significantly different to the Time-to-Play (TTP) of the scheduled media, the renderer module 60 can make the necessary modifications. This is done by first identifying the dynamic components within the media, as represented by step 440 and the type and required parameters of the dynamic components, step 450. Once the type and required parameters are determined, an appropriate replacement component can be selected from the component list 65, as represented by step 460. Once this step is complete the media becomes known as real-time media 72.

At this stage, with reference to step 470, a check is made to determine if any input has been made that would modify the media that is currently playing. This input could be in the form of a button being pressed by a user on a panel to play a particular media. If this occurs, the current real-time media is paused, the selected media is located, as represented by step 480. The selected media is loaded and begins to play, as represented by step 490. Once this media has run completely (unless interrupted by an internal or external input), the scheduled real-time media is resumed.

Effects, transitions and modifications to components are applied individually. With reference to step 500, if there are components to be presented, the first step in presenting a component is to apply the scheduled or default appearance to the component, as represented by step 510. Next, with reference to step 520, all external inputs are checked to determine if any modification to the appearance of the component is necessary, step 530. An example where this may be the case is when a noise cancelling audio sensor determines that the noise level in a location has risen to a certain level and amplification of a particular component is necessary. If necessary, the changes to the presentation are applied, step 540. Finally, any required transitions are applied to the component before it is presented, as represented by step 550. Such a transition may be a fade between two components.

With reference to step 560, each component is presented one after another and, with reference to step 570, the timer is updated to reflect the new time until no more components are left to be presented. A check is made at step 580 to ensure the media has not played through its pre-determined duration. If the duration of the media as not been reached, step 470 is re-visited to check for any input that would provoke a change to the media currently playing and continues until the duration of the media is reached. When the duration of the media is reached, with reference to step 590, the next scheduled media is selected from the final play-list 62 and the process begins again.

The truly dynamic nature of the combined scheduling and rendering system of the present invention is evident in its application as a powerful training aid. Training material can be driven at will by a presenter/operator bringing to the screen at any time the required content. Functions available include pause, rewind, replay, skip, fast forward etc.

Clearly, the present invention provides a highly flexible system and method of advertising content management and presentation that enables a wide range of organisations to promote advertising material in a large variety of ways in many different environments and scenarios.

Another application of the present invention is referred to as a Virtual Sales Person application that enables targeted advertising and messaging as a direct result of the application of dynamic control being applied to the components of the media during the scheduling process and the rendering process described above.

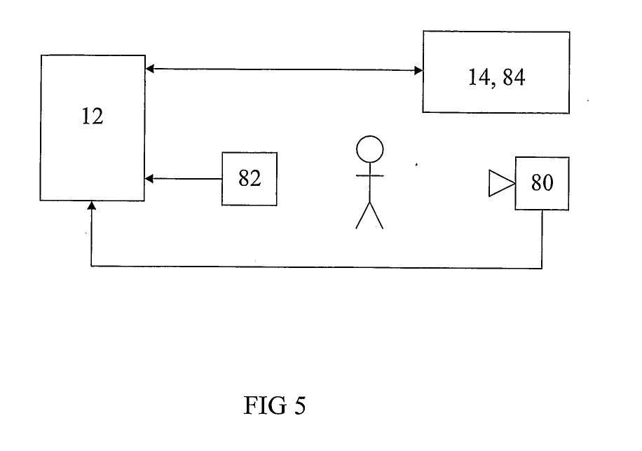

With reference to FIG. 5, in addition to the store control unit (SCU) 12 and the visual and audio output devices 14, the system comprises a customer interface, which, in one embodiment, includes an image capture device such as video camera 80, and/or a motion sensor, such as a passive infra-red (PIR) motion detector 82, and/or a sensitive/voice activated screen 84 coupled to be in communication with the SCU 12 and, according to one embodiment, coupled to be in communication with the controller 50.

The media and the components to be used in the media are selected and controlled dynamically by various events including, but not limited to, motion detection, sound detection, sound level via noise cancelling, any user interface, time of day, run time, date, location. All attributes of components are controlled dynamically including, but not limited to, the attributes of size, position, transparency level, colour, volume, opacity. The components are accessed from the store control unit 12 when instructed by the scheduler module 58 and/or the renderer module 60. The instructions can be in part or wholly as a result of the play list 62 or any dynamically generated request at the run-time.

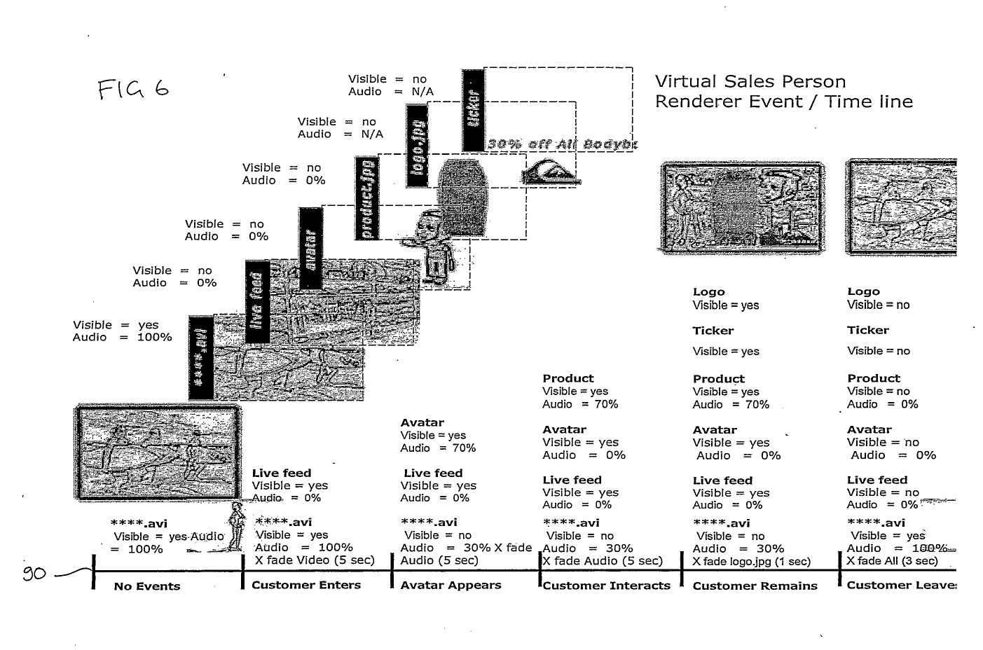

An example of the virtual sales person is shown in FIG. 6 and the sequence of events progresses along the time line 90 from left right. With reference to the “no events” section, when there are no customers in the vicinity of the video camera 80, motion detector 82 and/or sensitive/voice activated screen 84, in one embodiment the images are visible and the audio is at 100%. In this embodiment, an audio video interleave (.avi) file is employed, but alternatives can be used. In another embodiment, in the absence of customers being detected, neither the images nor audio will be active or one or the other can be active if desired.

When a customer enters, for example, a store, (“customer enters”) the .avi images are visible and the audio is at 100%. The live feed relays images captured by the video camera 80, for example of the customer, and includes the images of the customer in the presentation. There is a video cross fade for a period of, for example, 5 seconds and the live feed is visible, but the audio for the live feed is not audible. Next, as depicted further along the time line 90 in the section “avatar appears”, the avatar (animated 3D component) is made visible and its associated audio level is set at 70%. The live feed settings remain the same, but the .avi images are no longer visible and the associated audio is cross faded over 5 seconds to the 30% level in this embodiment.

Where the customer interacts with the system (“customer interacts”), via any of the customer interface elements, such as the motion sensor 82 or video camera 80, the live feed and .avi settings remain the same, but the audio associated with the avatar is dropped to 0% and the product being advertised is made visible and its associated audio level elevated to 70% to attract and engage the customer. Where the customer remains (“customer remains”) as detected by the motion sensor 82 and/or video camera 80, the product logo is made visible along with associated text, such as a ticker displaying the price, product features, a discount, bonuses, freebies or the like. Where the customer leaves the store or moves on to another part of the store (“customer leaves”), the logo, ticker, product images and audio, avatar data and live feed data are no longer visible or audible and the original images and audio are displayed.

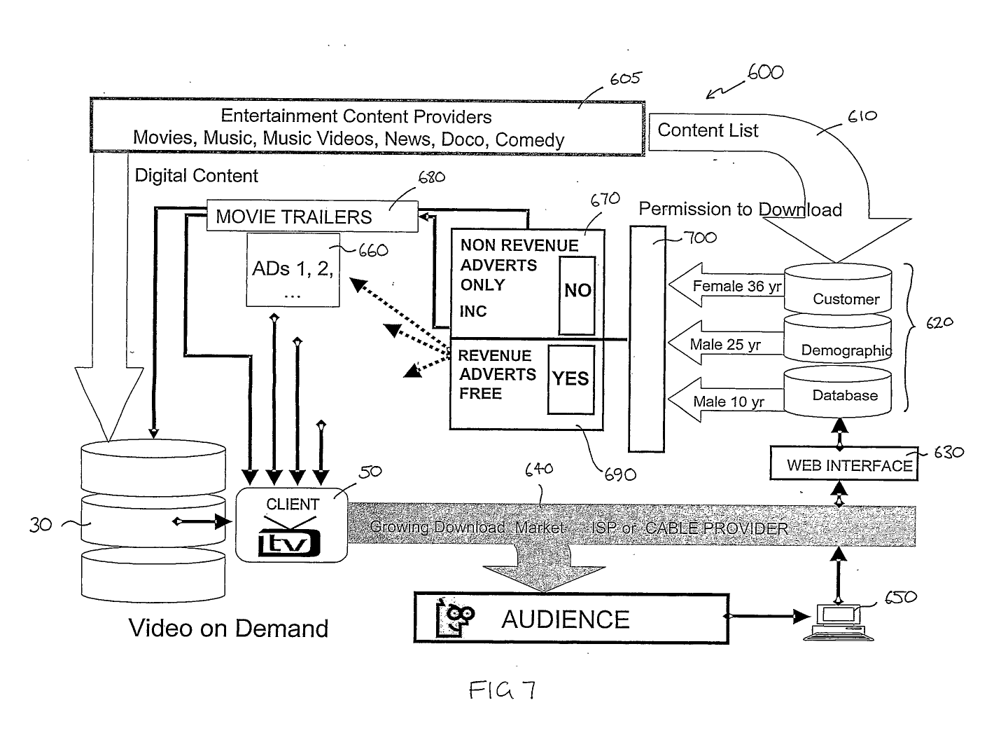

Another application of the present invention is “entertainment on demand”, such as “video on demand”. The purpose of this application of the controller 50, scheduler module 58 and renderer module 60 of the system 10 is to download and view and/or listen to entertainment content. With reference to FIG. 7, the system 600 comprises entertainment content 605 sourced from entertainment content providers, an entertainment content data list 610, a customer demographic database 620, a web based user interface 630 coupled to be in communication with the database 620, communication and delivery via cable/high speed internet connection 640 from a cable provider or internet service provider (ISP) coupled to be in communication with a user (audience) interface device 650. In FIG. 7, user interface device 650 is depicted as a person computer (PC) including visual/audio display. However, it should be appreciated that in other embodiments, user interface device 650 can also be a laptop computer, personal digital assistant (PDA) or other communication device, such as a mobile telephone. In other embodiments, user interface device 650 can also be one or more of the aforementioned output devices 14, such as a screen coupled to a set top box, hard drive or the like that enables a user to make selections and view content.

The user (audience) selects from the entertainment content data list 610 via the user interface 650. The selection of entertainment is combined with demographic data from database 620 and matched to components from an advertisement database 660 depending on an advertising option selected by the user. If the ‘No’ option 670 is selected by the user, only non-revenue components can be selected, such as movie trailers, further download offers, etc. If the ‘Yes’ option 690 is selected, components are selected from all available advertising components and matched using demographic info, movie choice and preferences if indicated by the user. Permission 700 allowing download of entertainment content is subject to conditions, such as prior payment, acceptance of advertising content, membership or any other defined condition such as user age, and is provided to the download site. The selected media and any components that may be required based on run-time instructions are assembled by the controller 50, scheduler module 58 and renderer module 60 and uploaded to the customer device 650. The entertainment content may be distributed from one of many entertainment content mirror sites.

The number of times or number of days that the entertainment can be accessed is controlled by the controller 50. Each time the entertainment is viewed, components are reselected dynamically according to rules. For example, an advertisement run at 9.00 a.m. during entertainment may be a coffee advertisement and the advertisement run at 8.00 p.m. may be an alcohol advertisement.

Dynamic components selected can be subject to predetermined parameters such as audience classification/actual run-time or any input during run-time.

The viewing rule can vary from once to an unlimited number. Under the unlimited viewing model, new media and components would automatically download whenever the customer logged on to the web interface 630 and seamlessly upload ready for the next viewing. All transactions are logged as proof of purchase to the advertiser.

This process can be further automated to download particular content whenever it becomes available always with fresh and relevant advertising which has already been pre-approved for delivery. This model of entertainment would therefore rival free-to-air television as an advertising medium and, in its purest business application, be free to customers who choose to accept advertising. According to one embodiment, customers can also choose the advertisement format. For example, all advertisements could be grouped to run at the start of a programme. Advertisers could also choose to advertise in conjunction with symbiotic or complimentary products from other advertisers, which could be interleaved as desired by the controller 50, scheduler 58 and renderer 60.

Another application of the present invention is in situations where it is imperative that changes in conditions or parameters are brought to the attention of an observer as soon as possible. Examples of such situations include, but are not limited to, medical and emergency environments, such as hospitals, plant monitoring, mining environments, aircraft and air traffic control environments. For example, the present invention could be utilised for presenting patient critical information, such as heart rate, blood pressure, temperature and the like. Under normal patient conditions, or within acceptable tolerances according to the patient's condition, age, gender etc., the patient critical information could be displayed in a particular font and colour with or without associated audio. In a critical or emergency condition, such as the patient experiencing cardiac arrest, one or more elements of the patient critical information could be displayed in a much larger font and more eye-catching colour to attract the observer's attention as soon as possible. This change could be accompanied by a very audible change in, or the introduction of, associated audio. Multiple patients could be monitored simultaneously via a live feed, each patient having associated parameters determining how their patient critical information is displayed. For example, acceptable tolerances of patient critical information for a toddler are unlikely to be acceptable for an 80 year-old. Similar display varying capabilities would also be of great value in monitoring conditions of plant machinery and mine sites and in air traffic control situations, for example, to display aircraft on safe courses differently from those on a collision course.

Hence, the systems and methods of the present invention thus provide a solution to the aforementioned problems of the prior art by virtue of the controller 50, scheduler module 58 and renderer module 60 of the presentation content management and creation systems and methods. The disadvantages of the prior art looped systems are avoided because the present invention dynamically controls the selection, scheduling and rendering of the media components to avoid the repetition of the prior art. The present invention can produce a continually varying presentation where desired and can vary the content according to the required effects, the environment, such as background noise, interaction from customers/users and both internal and external interrupts and inputs, such as those derived from patients/machinery, as described above. Changes up to 30 times per second within the time line of the presentation can be performed to modify the presentation to include, for example, forced play list content, as described above. Because all of the production or rendering is done as the media is being displayed, this allows us to completely control and modify all of the attributes, such as, but limited to, the colour, opacity, position, size, volume, layer order, font size and style, blend level transparency, etc.) of each media component, whether that be an image or a text field or any other component at any time.

The Video On Demand delivery methods enable targeted advertising and associated revenue streams as direct result of the application of the dynamic control of the components of the media during the scheduling and rendering processes.

The Virtual Sales Person methods enable targeted advertising and messaging as a direct result of the application of the dynamic control of the components of the media during the scheduling and rendering processes.

The system and methods described with respect to the scheduler module 58 and renderer module 60 are designed to allow control of any available attributes of any available component by way of sensing from any source an input command. Such input can then be made to vary the resultant presented media dynamically as it is displayed to the visual and audio output devices 14 of the system. The extent of control extends to, but is not limited by, component selection and presentation with presentation comprising one or more of size, position, colour, font, duration, opacity, visibility, and volume. Determinations thereof are continually made regarding these component attributes by the renderer module 60 and are limited only by the processor in the SCU 12.

The level of control afforded by the invention gives rise to the presentation, and in particular, advertising creation and delivery system which can be accessed by simple web based interfaces. The resultant dynamic content can not only be tailored to have a unique look and feel, but also deliver a unique result each time it is viewed. The system is 100% scalable and high video production costs are eliminated. Furthermore, the file sizes associated with this method of content production and presentation are reduced to a fraction of the size of a traditionally produced video file, but deliver the high definition content required by today's modern screens. The present invention allows media to be a composition of many smaller components, such as images, text fields, audio files, etc., which significantly reduce the overall size of the media. This file size compared to play time is completely disproportionate by current standards. For example, a 30s advertisement can occupy a mere 1 MB in the present invention. This brings another clear advantage when, for example, a presentation is delivered by broadband to a consumer's home. Downloaded content begins playing immediately and because further content can be downloaded during this play time, the resultant delivery can be seamless.

The control of the rendering process via timelines that interact dynamically with the schedule allows the same level of control available from current DVD players. Skip, Skip to, Repeat, Fast Forward, Rewind, Pause, Freeze, Picture-in-Picture (PIP) are all functions of control of display attributes of content components and as such can be made available at all times to the viewer. This level of functionality further allows the user to drill down and request further information as a result of an onscreen prompt in the form of a message, offer or the like. The auditing and reporting available allows for advertisers to be billed only after the content has been viewed and for their advertisement to be only offered to their desired demographic. The advertiser can be billed at differing rates based on, for example, the degree of demographic match achieved or the varying levels of interactivity.

Alternatively viewers can choose to accept advertising only from categories and companies of their choice. Advertising can be democratised and made affordable to the point that the local trader may compete equally with multinational companies for the viewers attention while still ensuring a revenue stream appropriate to the content which is at least equal to, but may under this system due to market demands be greater than that currently developed by free to air television.

The invention can also be applied across many differing platforms, such as IP telephony networks, Mobile 3G networks and viewed on desk top Video phones, handheld devices and the like.

Throughout the specification the aim has been to describe the invention without limiting the invention to any one embodiment or specific collection of features. Persons skilled in the relevant art may realize variations from the specific embodiments that will nonetheless fall within the scope of the invention.

1. A presentation content management and creation system comprising:
a database of sorted media components;
a controller coupled to be in communication with the database for scheduling and rendering media components selected from the database into a real time media presentation;
at least one output device coupled to be in communication with the controller for outputting the real time media presentation;
wherein in response to one or more inputs to the controller, one or more attributes of the one or more selected media components scheduled for presentation is modified as the real time media presentation is displayed by the at least one output device.

2. The system of claim 1, further comprising an administrator module coupled to be in communication with the database and the controller.

3. The system of claim 2, wherein the database, the controller and the administrator module are coupled to be in communication in a store control unit.

4. The system of claim 1, wherein the media components selected from the database include at least one of the following: a static media component, a dynamic media component.

5. The system of claim 4, wherein a dynamic media component is selected when a change in the real time presentation is required.

6. The system of claim 1, wherein at least one attribute of at least one of the dynamic media components is determined by the controller.

7. The system of claim 6, wherein attributes of the media components include: colour, opacity, position, size, duration, volume, layer order, text size, text style; blend level transparency or combinations thereof.

8. The system of claim 1, further comprising a customer demographic database coupled to be in communication with a user interface device and the database of sorted media components.

9. The system of claim 8, wherein the user interface device also functions as the at least one output device.

10. The system of claim 1, wherein at least some of the media components in the database of sorted media components are provided by entertainment media content providers.

11. The system of claim 8, wherein in response to one or more selections made by a user via the user interface, the real time media presentation is communicated to the at least one output device.

12. The system of claim 8, wherein the one or more selections made by the user include selecting whether or not advertisements are to be included in the real time media presentation.

13. The system of claim 12, wherein if advertisements are to be included in the real time media presentation, the advertisements are selected by the controller on the basis of data relating to the user stored in the customer demographic database.

14. The system of claim 13, wherein said advertisements are selected from an advertisement database coupled to be in communication with the controller.

15. The system of claim 1, wherein the media components scheduled and/or rendered by the controller are determined at least partially in response to signals detected by one or more of the following devices coupled to be in communication with the controller: an image capturing device, a motion sensor, a sensitive/voice activated screen.

16. A controller for a presentation content management and creation system, said controller comprising:
a scheduler module for selecting media components from a database of sorted media components and creating a play-list of scheduled media components; and
a renderer module for rendering the scheduled media components into a real time media presentation displayed by at least one output device coupled to be in communication with the controller;
wherein, in response to one or more inputs to the controller, one or more attributes of the one or more selected media components scheduled for presentation is modified as the real time media presentation is displayed by the at least one output device.

17. The controller of claim 16, wherein the scheduler module randomly selects media components from the database of sorted media components via a list of media components stored in the controller.

18. The controller of claim 16, wherein the media components are sorted at least by a media category required in the presentation.

19. The controller of claim 16, wherein the scheduler separates the scheduled media components into dynamic components and static components.

20. The controller of claim 19, wherein the dynamic components, if required, are selected according to one or more identifying parameters specified for said dynamic components.

21. The controller of claim 16, wherein the renderer module separates the components constituting the scheduled media into dynamic components and static components.

22. The controller of claim 21, wherein the renderer module reselects at least one of the dynamic components when a change in the real-time presentation is required.

23. The controller of claim 21, wherein the renderer module combines the static components and the dynamic components in the real-time presentation.

24. The controller of claim 16, wherein the sorted media components are sorted by a media subcategory required in the presentation.

25. The controller of claim 16, wherein the renderer module changes the presentation of a media component due to one or more of the following: an internal input, an external input.

26. The controller of claim 16, wherein attributes of the media components include: colour, opacity, position, size, duration, volume, layer order, text size, text style, blend level transparency or combinations thereof.

27. A method of creating and presenting a presentation including:
selecting media components from a database of sorted media components;
creating a play-list of scheduled media components;
rendering the scheduled media components into a real time media presentation as the real time presentation is displayed by at least one output device; and
modifying, in response to one or more inputs to a controller, one or more attributes of the one or more selected media components scheduled for presentation as the real time media presentation is displayed by the at least one output device.

28. The method of claim 27, further including separating the media components constituting the scheduled media into dynamic components and static components.

29. The method of claim 28, further including changing at least one of the dynamic components when a change in the real time media presentation is required.

30. The method of claim 29, wherein changing at least one of the dynamic components includes:
determining a type and at least one parameter of the at least one dynamic component that requires changing; and
selecting a replacement component from at least one component list according to the parameters.

31. The method of claim 28, further including combining the static components and the dynamic components in the real-time media presentation.

32. The method of claim 27, further including recording details of the media components for auditing purposes once displayed in the real time media presentation.

33. The method of claim 27, wherein modifying one or more attributes includes modifying: colour, opacity, position, size, duration, volume, layer order, text size, text style, blend level transparency or combinations thereof.

34. A presentation content management and creation system comprising the controller of claim 16.
